(19) United States
(12) Patent Application Publication
(10) Pub. No.: US 2006/0059363 A1
(43) Pub. Date: Mar. 16, 2006

(54) Method for controlling access to a computerized device

(76) Inventors: John Carl Mese, Cary, NC (US); Nathan J. Peterson, Raleigh, NC (US); Rod David Waltermann, Rougemont, NC (US); Arnold S. Weksler, Raleigh, NC (US)

Correspondence Address: LALLY & LALLY, L.L.P., P. O. BOX 684749, AUSTIN, TX, 78768-4749, US

(21) Appl. No.: 10/942,168

(22) Filed: Sep. 16, 2004

(51) Int. Cl. H04L 9/00

(52) U.S. Cl. 713/185

(57) ABSTRACT

Controlling access to a computerized device includes deriving a hash from two pieces of information, signing the hash to create a signed password and storing the password in the device. In response to an initial access attempt, the user is prompted to enter two input values. A local hash is then derived from the two input values and compared to a hash derived from the stored password. Upon detecting a match between the hashes, the user is granted access to the device, where the match indicates equivalence between the two pieces of information and the two input values. The input values may include information specific or personal to the user and information unique to the device. A public/private key pair may be used to sign and optionally encrypt and decrypt the stored password.

### BACKGROUND

1. Field of the Present Invention

The present invention is in the field of data processing systems and other computer devices and, more particularly, controlling access to computerized devices.

2. History of Related Art

Passwords and other access control mechanisms are well known in the field of computerized devices. Typically, passwords are created by or in conjunction with the user after the user has gained access to a computerized device. Before the password is set by the user, access to the computerized device is generally unrestricted. Alternatively, a computerized device may be shipped or delivered with a preset password. The provider of the computerized device, whether the provider is the end user's vendor, employer, or other entity, provides the pre-set password to the end user in an external communication (such as by email, regular mail, fax, voice mail, etc.).

The current methods and techniques for controlling initial access to a computerized device have significant drawbacks. Foremost, many computerized devices are delivered to their end users without any access control mechanism at all. If such a system is delivered to or otherwise ends up in the hands of an unintended user, there is no access control mechanism to prevent the unintended user from using the device. In cases where a preset password is delivered to the desired end user by means of mail or another technique, the password communication may be intercepted or otherwise compromised and used to access a device. Because the password communication contains all of the information needed to access the device (i.e., it contains the entire password), it is susceptible to compromise. It would be desirable implement an improved mechanism and method to control initial access to a computerized device.

### SUMMARY OF THE INVENTION

The identified objective is achieved according to the present invention, in which a provider of a computerized device delivers the device to an end user. The invention leverages three distinct password components that when joined together provide a unique method for accessing the computerized device. The device includes storage that contains a password. The password is generated by the provider based on a first piece of information that is unique to or known by the end user and a second piece of information that is unique to the device itself. In one embodiment, the user-specific information and the device specific information provide inputs to a hashing algorithm that produces a hashed value based on the first and second pieces of information. The hashed value is signed, and optionally encrypted using a private key known by the provider to create the password that is stored on the device. The user specific information is preferably a piece of information known to the user, but generally unknown to others. The device specific information is preferably a machine/type/model (MTM) number, serial number, or other information that is unique to the specific machine. The provider supplies a public key to the intended end user via an external communication, and this key is used to verify the signature and optionally decrypt the hashed value.

When the end user is in possession of the computer device, the initial boot of the device will cause an initial access user interface to appear. The user is requested to enter the user specific information, the machine specific information, and the public key information provided by the provider. When the user inputs these values, the computerized device hashes the user specific and machine specific values to create a local hash value. The device locates and optionally decrypts stored hash using the provider-provided public key. The stored hash is then compared to the locally generated hash value. In addition, the stored hash's signature is checked using the provided public key. If a match is detected, the user is given access to the computerized device and normal booting continues. If a mismatch occurs, the user may be given a second or third opportunity to enter the information, but access to the device is otherwise denied until a match is produced. By incorporating information that is unique to the computerized device, unique to the intended user, and information that is controlled by the provider, the present invention provides assurances against both delivery of the wrong system and delivery to the wrong person. In addition, the provider controlled information enables the provider to control access to the device temporally such that, for example, access to the device is not authorized until a specified event occurs.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a system and method by which a provider delivers computerized devices to end users according to an embodiment of the present invention;

FIG. 2 is a block diagram illustrating details of the method and system of FIG. 1 according to one embodiment of the invention; and

FIG. 3 is a block diagram illustrating details of the method and system of FIG. 1 according to a second embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention is concerned with controlling the initial access to a computerized device following delivery of the device to an end user by a provider. The provider is most likely responsible for delivery of computerized devices to multiple end users. Moreover, the provider preferably has a relationship with the end user that permits the provider to obtain or have access to at least some information that is unique or personal to the end user. The provider generates a value that is derived from information that is personal to the intended end user as well as from information that is unique to the intended computerized device. This value is signed and preferably encrypted according to a private key known only to the provider to create an initial access password. The provider then stores the initial access password in a safe place on the computerized device. Such places may include but are not limited to flash, EEPROM, the hard disk, or in a TPM (Trusted Platform Module). When the computerized device is delivered to an end user and the user boots the device for the first time, code embedded in the device's boot sequencer or operating system will recognize the boot event as an initial access and respond by prompting the user to enter the personal information and the device specific information. The code will then generate a local value from the user inputs. For implementations that include encryption of the stored password, the code also prompts the user for a public key that is supplied to the user by the provider. The code decrypts the stored password using the public key and compares the decrypted stored password to the locally generated value. If a match is detected, the user is permitted to access the device and normal booting continues. If no match is detected, the user may be given additional opportunities to enter the information correctly, but the user will not gain access to the device until a match is found.

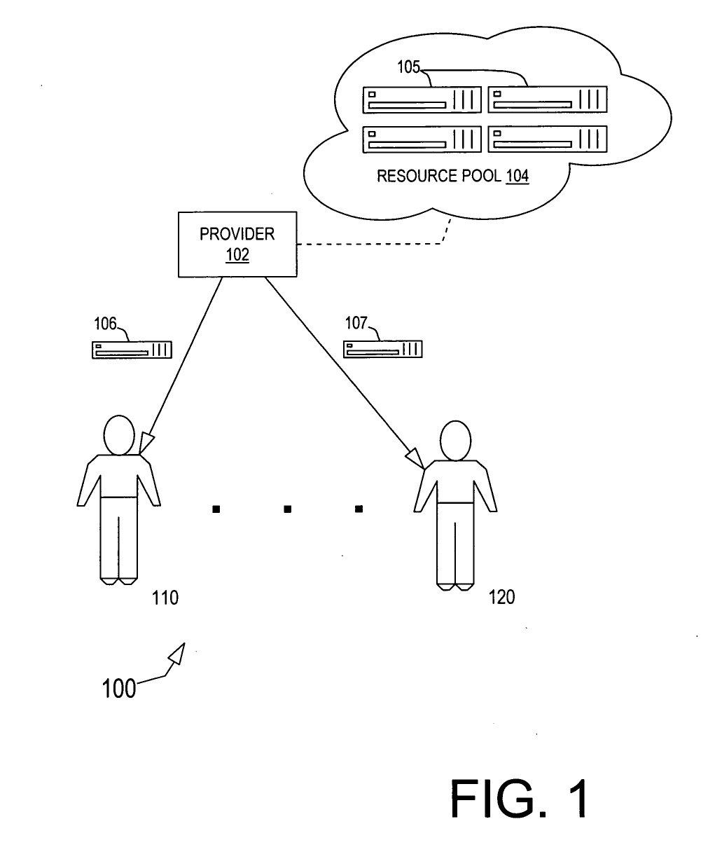

Referring now to the drawings, FIGS. 1 through 3 are presented to illustrate the context in which some implementations of the invention are suitable and to illustrate selected details of the invention. FIG. 1 presents selected elements of an environment 100 in which computerized devices are delivered to end users by a provider. In the context of this disclosure, a provider refers to a person, department, company, or other entity that is responsible for getting a computerized device to an end user and is specifically not limited to a manufacturer or distributor of computerized devices. The provider, represented by referenced numeral 102, has access to a pool 104 of computerized devices 105. When end users 110 and 120 require or request computerized devices, provider 102 is responsible for insuring that each end user receives the correct computerized device. In the depicted implementation, for example, first end user 110 requires or requests computerized device 106 and second end user 120 requires or requests computerized device 107. Provider 102 must satisfy the request or requirement by selecting computerized device 106 from resource pool 104, ensuring the device is properly configured for the required or requested task, and deliver it to the appropriate end user 110. Provider 102 must repeat this process for each end user that is to receive a computerized device.

In the most likely implementations of the invention, provider 102 and end users 110 and 120 have a relationship that gives provider 102 access to some information that is personal to the end user. In one example, provider 102 is an employer of end users 110 and 120 or a division of an employer of end users 110 and 120. In this example, the employer maintains human resources records for each of its employees. These records include information about the end user that is not generally known to the public such as social security number, emergency contact information, employee numbers if applicable, and any of a host of other records that the employer may request the employee to provide when the employee is first hired. The additional information that the employer may request of the employee may include one or more pieces of information specifically used to create initial access passwords for any computerized devices that the employee might receive from the employer or an IT department of the employer. Familiar examples of this type of information are the maiden name of the employee's mother, the name of a pet of the employee, and so forth.

In another context, the provider is a commercial seller of computerized devices and the end user is a consumer. The consumer may establish an account with the seller that enables the seller to process orders requested by the consumer. The account information that the seller obtains from the consumer prior to taking any order may include information that is unique to or personal to the consumer such as the mother's maiden name and pet's name examples referred to in the preceding paragraphs. The account may be established by any conventional means including, for example, online, via mail or facsimile, and so forth.

Returning to FIG. 1, provider 102 receives orders or requests for computerized devices from end users 110 and 120 or otherwise determines that the end users require or would benefit from computerized devices. In the case of a user request for a computerized device, the request may include one or more requirements, specifications, or limitations on the computerized device requested including perhaps, make and model requirements, CPU requirements, storage requirements, memory requirements, and so forth.

Provider 102 is responsible for configuring or otherwise obtaining a computerized device 105 from pool 104 that complies with the request. In the case of a provider-initiated determination that an end user needs a computerized device, the provider may determine the appropriate features or details of the device. In either case, however, it is important that the computerized device chosen for the end user is the computerized device that the end user receives. Specifically, it is important to safeguard against simple handling and shipping errors that result in mis-delivery of a particular device as well as malicious events such as theft or the intentional replacement of a hard disk. FIG. 1 uses unique reference numerals for computerized devices 106 and 107 to convey the concept of delivering the correct computerized device to the correct end user. Thus, as depicted in FIG. 1, a first end user 110 is the intended end user for a first computerized device 106 while a second end user 120 is the intended end user for a second computerized device 107. Computerized devices 106 and 107 may have been selected from resource pool 104 and may have specific configurations according to end user requests or specifications, provider-determined specifications, or a combination of both.

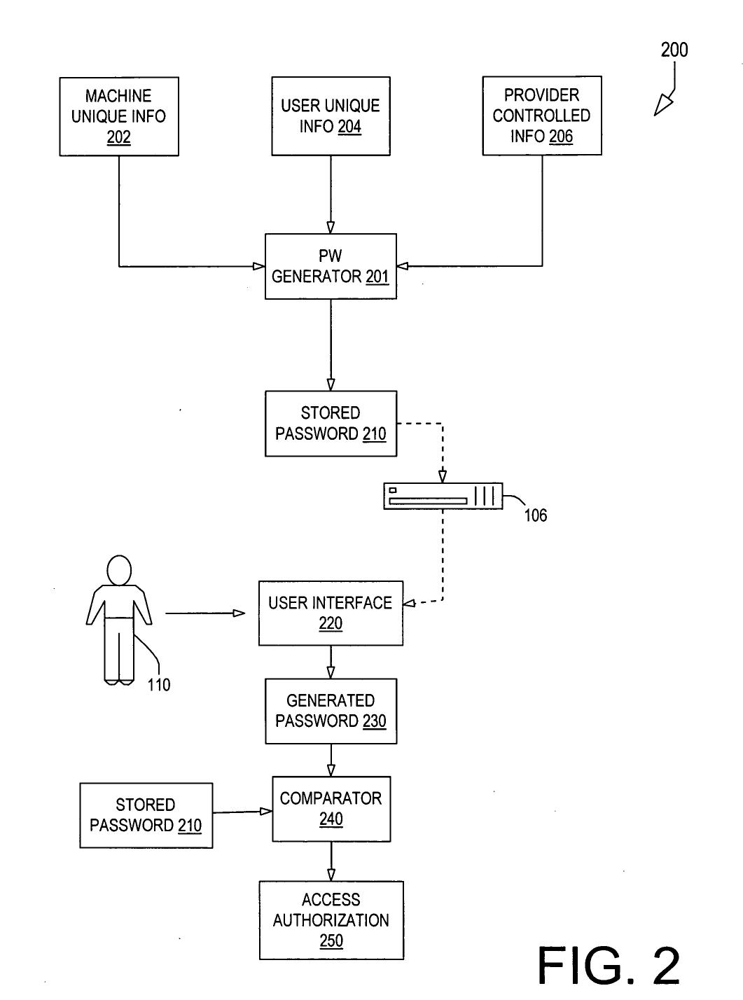

Referring now to FIG. 2, a method 200 of providing computerized devices to end users in a manner that promotes initial access authorization is conceptually depicted. As depicted in FIG. 2, a password generator 201 receives information from three sources and generates a stored password 210 using, derived from, or otherwise based on the three sources of information. In the depicted implementation, password generator 201 receives information 202 that is unique to the computerized device, information 204 that is unique to or personal to the intended end user, and information 206 that is controlled by the provider. Device unique information 202 may include a serial number or make, type, and model number information sufficient to identify the device uniquely. Personal information 204 is acquired from the end user by the provider, usually in a communication that occurs outside the context of the delivery of the computerized device. As indicated earlier, for example, personal information 204 might include a value specified by the user as part of an initial interview performed by human resources when the end user is first employed by the provider. Personal information 204 may also be specified during the creation of an account with the provider prior to requesting or purchasing the computerized device. Isolating the specification of the personal information 204 from the transactions or communications that are specific to the delivery of the computerized device provides an additional measure of security and assurance that the intended user will be the only user that can successfully boot the computerized device.

Password generator 201 uses information 202, 204, and 206 to generate or calculate a stored password 210. Generation or calculation of stored password 210 from information 202, 204, and 206 includes the use of hashing algorithms, digital signatures, and (optionally) encryption algorithms, or a combination of the above although specifics of the password generation technique are an implementation detail. Generally, the technique used to generate stored password 210 must, at a minimum, provide a high degree of assurance that the stored password is unique and a high degree of assurance that the password itself cannot be used to determine the method by which nor the original information (202 and 204) from which the password was generated.

As its name implies, stored password 210 is stored on the computerized device 106 intended for delivery to end user 110. Stored password 210 is preferably stored in a secure storage location of the device. This secure location could be, for example, encrypted on a hard drive, in a secured area of BIOS, or within a trusted platform module (TPM). A TPM is a hardware component that provides, among other items, secured storage locations. At this writing, the complete specification of the TPM (Version 1.2) is available from the trusted computing group (TCG) web site at trustedcomputinggroup.org.

After trusted password 210 is stored in computerized device 106, computerized device 106 is shipped or otherwise delivered to an end user represented in FIG. 2 by reference numeral 110. End user 110 is, of course, preferably the intended end user for computerized device 106, but computerized device 106 includes stored password 210 and supporting code necessary to verify end user 110 as the intended end user.

After receiving computerized device 210, end user 110 performs an initial boot sequence when the user powers on the device for the first time. Computerized device 106 may include some form of installed code that facilitates the creation of a desired image on computerized device 106. An image is the collection of operating system, device driver, and application modules that give the computerized device its functionality. An exemplary image creation product is the ImageUltra Builder (IUB) product from International Business Corporation. In embodiments having an IUB or other similar component, the IUB may include or be modified to include an interface that is presented to the user during an initial boot sequence. In other embodiments, a custom interface is created.

A user interface 220, whether it be custom code or an extension of an existing image creation program, is presented to end user 110 during an initial access sequence. An initial access sequence refers to any access attempt that occurs before the stored password in computerized device 106 is verified. User interface 220 prompts the end user 110 to provide selected specified pieces of information. Specifically the interface prompts the user to provide information that is the same as or parallels the information upon which the stored password 210 was derived. Thus, if the creation of stored password 210 involved the use of the maiden name of the end user's mother, user interface 220 will prompt the user for this information although interface 220 might not refer to the information required explicitly (e.g., user interface 220 might not request “MOTHER'S MAIDEN NAME,” but instead may request the user specific or user personal information more vaguely such as “ENTER PERSONAL INFORMATION”). Similarly, user interface 220 prompts the user for device specific information and for any information received from and controlled by the provider.

End user 110 must respond to the user interface prompts to gain access to the system. Upon detecting responses to each of the required fields of information, user interface 220 includes code that enables it to derive or compute a password, referred to herein as the locally generated password 230 or simply generated password 230. Moreover, if the user's responses to the prompts of user interface 220 are the correct responses, the generated password 230 and the stored password 210 will match.

A comparator 240, most likely implemented in the software code of user interface 220, compares the locally generated password 230 to the stored password 210, which is securely stored on computerized device 106. If the comparator determines that the generated password 230 and stored password 210 are the same, access authorization 250 is provided to end user 110. If, on the other hand, comparator 240 determines that generated password 230 and stored password 210 do not match, access authorization is denied. The end user 110 may be given additional (preferably limited to three or less) opportunities to enter a correct set of responses, but end user 110 will not gain access to computer device 106 (i.e., be able to load and use an operating system and one or more application programs).

Upon successfully matching generated password 230 to stored password 210, computerized device 106 continues with a conventional boot sequence in which an operating system image is installed, application programs may be loaded, and the user is ultimately given access to the device (i.e., the user has access to the programs installed on and the storage system of computerized device 106). In one embodiment, stored password 210 is intended for use as an initial access password only. Once the end user verifies that the correct computerized device has been delivered to and received by the intended end user (by matching generated password 230 to stored password 210), the sequence forcing the user interface 220, or at least those portions of user interface 220 directed at matching stored password 210 are bypassed. In such embodiments, a single successful completion of the password matching sequence described herein bypasses the code from that point forward thereby making the computerized device available for use by any user absent additional password or security measures.

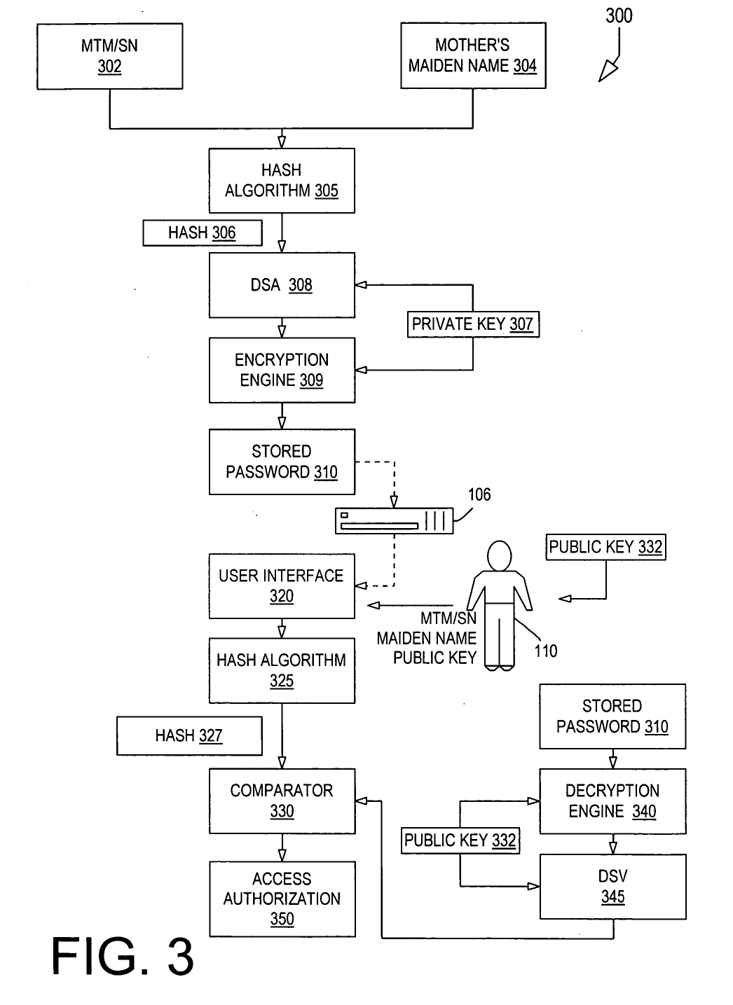

Additional details of a possible implementation of the present invention are presented in FIG. 3. Specifically, FIG. 3 depicts an implementation of a method 300 for verifying delivery of a computerized device that includes using specified pieces of information for the personal information, machine specific information, and the provider controlled information described above.

As depicted in FIG. 3, method 300 includes the use of Machine/Type/Model (MTM) information, serial number information, or a combination of the two as the machine specific information 302. The machine specific information 302 may be stored within computerized device 106 and electronically accessible to a program executing on the device, possibly as part of or as an extension of the vital product data (VPD) currently defined on some computerized devices. VPD is device-specific information stored on a device's hard disk (or the device itself) that allows the device to be administered at a system or network level. Typical VPD information includes a product model number, a unique serial number, product release level, maintenance level, and other information specific to the device type. Vital product data can also include user-defined information, such as the building and department location of the device. The collection and use of vital product data allows the status of a network or computer system to be understood and service provided more quickly. This embodiment contemplates a mechanism in which the provider can implement an automated or partially automated system for creating stored passwords 310.

Alternatively, the machine specific information 302 may consist of or include information that is obtainable by physical inspection of computerized device 106. A unique serial number, for example, if not contained in VPD or some other electrically accessible location, is obtained visually from the chassis of the device itself. An embodiment of the invention that requires the provider to have possession of the computerized device, although less susceptible to automation, beneficially increases the difficulty required to compromise the system's security because the provider must have the computerized device in hand to re-create the stored password.

The depicted embodiment of method 300 also indicates the user personal or user specific information 304 as being comprised of the maiden name of the user's mother. It will be appreciated, of course, that user personal information 304 may consist of any information that is known to the end user and conveyed to the provider, but is otherwise generally not known by others, except perhaps those whose have a close personal relationship with the user. While user personal information is susceptible to compromise because it may be discovered or inadvertently disclosed, it enjoys the advantage of being user friendly. While more secure user specific information can be imagined, user personal information such as mother's maiden name has a substantial degree of security as well as a high degree of being memorable to the user.

As depicted in FIG. 3, a hashing algorithm 305 receives the device specific information 302 and the user specific or user personal information 304 as its inputs. Hashing algorithm 305 represents any of a variety of widely known hashing algorithms such as the Secure Hashing Algorithm (SHA) or message digest algorithm (MD5). These particular algorithms receive a variable string of bits as input and create a unique, fixed-length “message digest” derived from the input string. The message digest or other similar output from the selected implementation of hashing algorithm 305 is generically identified in FIG. 3 as hash value 306.

For the depicted implementation, in which hash algorithm 305 receives two inputs, some form of manipulation of the inputs is contemplated. In perhaps the simplest case, the device specific information 302 and the user personal information 304 may be simply concatenated to form a single bit stream that is provided to the hashing algorithm. In other implementations, more complex manipulation of the inputs may be performed as desired.

In the depicted embodiment, the hash value 306 generated by hash algorithm 305 is then passed through a digital signing method 308, which, in conjunction with a private key 307 maintained by the provider, produces a digital signature specific to the combination of machine specific information 302 and user personal information 304. Note that although a single key 307 is used for encrypting and signing, different keys may be used for each. The signature generated by DSA 308 is appended to the original data and optionally encrypted in encryption engine 309 using (in the depicted embodiment) the private key 307 as the encryption key to create the stored password 310. Thus, stored password 310 is a digitally signed and possibly encrypted representation of the machine specific and user personal information input by the user.

When the computerized device is delivered to and then initially booted by the end user, the end user is presented with a user interface 320. User interface 320 prompts the end user to input three pieces of information, namely, the device specific (e.g., MTM/SN) information 302, the user personal information (e.g., mother's maiden name) information 304, and a public key 332 that is sent to the end user by the provider in a communication external to or apart from the stored password information.

Upon receiving the user inputs, the user interface 320, using a hashing algorithm 325, which is functionally equivalent to hashing algorithm 305, creates the locally generated hash 327. The generated hash 327 may then be used to verify the stored password 310 using comparator 330. Specifically, stored password 310 may be optionally decrypted with decryption engine 340 using the public key 332. The signature of the password 310 is then decrypted by digital signature verification engine 345 using public key 332. The decrypted signature is then compared by comparator 330 against locally generated hash 327 to determine whether a match has occurred. If a match is detected, access is authorized in block 350.

By deriving passwords from information unique to the end user, the device, and the device provider, the present invention provides a high level of security against unauthorized initial access. It will be apparent to those skilled in the art having the benefit of this disclosure that the present invention contemplates a mechanism for authenticating initial access to a computerized device. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of providing a computerized device to an end user, comprising:
deriving a password from at least two pieces of information;
digitally signing the derived password using a private key and storing the signed password in storage of the computerized device;
responsive to a boot event following delivery of the computerized device to a user, determining if the boot event is an initial boot event and, if so, prompting the user to enter at least two input values;
deriving a local hash from two input values;
verifying a digital signature of the stored password using a public key;
verifying the local hash using the stored password and, upon verification, granting the user access to the computerized device, wherein verification indicates equivalence between the two pieces of information and the two input values.

2. The method of claim 1, wherein the at least two input values include a first input value indicative of information specific to the user and a second input value indicative of information unique to the computerized device.

3. The method of claim 2, wherein deriving the password from the at least two input values includes performing a hashing algorithm to generate a hashed value using the user specific information and the device specific information as inputs to the hashing algorithm.

4. The method of claim 3, wherein deriving the password from the at least two input values further includes encrypting the hashed value using a private key.

5. The method of claim 4, further comprising providing a public key to the end user and further wherein deriving the local hash includes performing the hashing algorithm on the two input values entered by the user.

6. The method of claim 5, further comprising decrypting the stored password signature, verify the signature using the public key and wherein comparing the stored password to the local password comprises comparing the decrypted and verified hash to the local hash.

7. The method of claim 1, further comprising, prior to deriving the password from the at least two pieces of information, obtaining a first piece of information specific to the user from existing records and obtaining a second piece of information uniquely identifying the computerized device.

8. The method of claim 7, wherein the end user is an employee of the provider and wherein the existing records include human resource records corresponding to the end user.

9. The method of claim 7, wherein the end user is a customer of the provider and wherein the existing records include account information records corresponding to the end user.

10. A computer program product for authorizing access to a computerized device, comprising:
computer code means for prompting a user of the computerized device to enter user personal information;
computer code means for prompting the user to enter information uniquely indicative of the computerized device;
computer code means for generating a local hash based on the user personal information and the computerized device information;
computer code means for retrieving a stored password from the computerized device;
computer code means for comparing and verifying the local hash using the stored password and the local password; and
computer code means for granting the user access to the computerized device responsive to verifying the local hash.

11. The computer program product of claim 10, wherein the computer program product includes user interface code means for said prompting of the user to enter the user personal information and the device information and further wherein the user interface code means is invoked only upon determining that an attempt to access the computerized device is an initial access attempt, wherein an initial access attempt comprises any access attempt made before the match is detected or set number of any initial access attempts.

12. The computer program product of claim 10, wherein the code means for generating the local hash includes hash algorithm code means for generating a hashed value from the user personal information and the computerized device information.

13. The computer program product of claim 12, wherein the code means for generating the local hash further includes code means for creating a string by concatenating the user personal information and the computerized device information and code means for using the concatenated string as input to the hash algorithm code.

14. The computer program product of claim 13, wherein the stored password is signed and encrypted using a private key and wherein the code means for verifying the local hash include code means for decrypting and verifying the stored hash signature using a public key and comparing the decrypted hash to the local hash.

15. The computer program product of claim 14, wherein the stored password is stored in a trusted platform module and wherein the code means for retrieving the stored password includes code means for accessing the trusted platform module.

16. A computerized device, comprising:
storage means containing an initial access password derived from user-personal information, device-specific information, and a private encryption key specified by a provider of the computerized device, and means for accessing the initial access password;
means for determining that an access attempt by an end user comprises an initial access attempt;
means, responsive to said determining that said access attempt comprises an initial access attempt, for prompting the end user to enter user personal information, device specific information, and a public key specified by the provider;
means for determining a local hash based on the user personal information and the device specific information entered by the end user; and
means for using the public key to verify the local hash signature using the stored hash and for granting the end user access to the computerized device if the local hash and the stored password match.

17. The computerized device of claim 16, wherein the storage means comprises secure storage within a trusted platform module of the computerized device.

18. The computerized device of claim 16, wherein the means for determining that an access attempt end user comprises an initial access attempt, includes means for determining that the end user has not been previously granted access to the computerized device.

19. The computerized device of claim 16, wherein the initial access password is derived by performing a hash algorithm using an input value derived from the user-personal information and the device-specific information and wherein the means for determining the local hash include means for performing the hash algorithm using the personal information and device specific information entered by the end user.

20. The computerized device of claim 16, wherein the user personal information comprises information contained in a preexisting record maintained by the provider.
